(19) United States
(12) Patent Application Publication
(10) Pub. No.: US 2014/0144941 A1
(43) Pub. Date: May 29, 2014

(54) Beverage Container

(71) Applicants: Ronald F. Horvath, RACINE, WI (US); BARBARA L. JENSEN, RACINE, WI (US); HELEN A. RUSK, RACINE, WI (US); ROBERT A. BALOW, RACINE, WI (US); NANCY T. ELSMO, OAK PARK, IL (US)

(72) Inventors: Ronald F. Horvath, RACINE, WI (US); BARBARA L. JENSEN, RACINE, WI (US); HELEN A. RUSK, RACINE, WI (US); ROBERT A. BALOW, RACINE, WI (US); NANCY T. ELSMO, OAK PARK, IL (US)

(21) Appl. No.: 14/167,669

(22) Filed: Jan. 29, 2014

Related U.S. Application Data
(63) Continuation of application No. 13/558,968, filed on Jul. 26, 2012, now abandoned.
(60) Provisional application No. 61/512,643, filed on Jul. 28, 2011.

(51) Int. Cl. B67D 3/00; B65D 85/72

(52) U.S. Cl. CPC B67D 3/0051; B65D 85/72
USPC 222/144.5; 220/500; 220/525

(57) ABSTRACT

A beverage container having at least two compartments within a liquid reservoir. Each of the compartments is selectively accessed, whereby liquid is only dispensed from the accessed compartment.

### RELATED APPLICATIONS

This application is a continuation of pending U.S. patent application Ser. No. 13/558,968, filed on Jul. 26, 2012, which claims priority to U.S. Provisional Patent Application Ser. No. 61/512,643, filed on Jul. 28, 2011.

### BACKGROUND OF THE INVENTION

This invention generally relates to beverage containers. In particular, the invention relates to a beverage container with selectable compartments. In the restaurant industry speed and efficiency are essential to providing quality service.

Beverage containers, such as coffee pots are conventionally known in the field and come in a variety of shapes and sizes. There are typically two types of coffee served in a restaurant, regular and decaffeinated (“decaf”) coffee. When refilling restaurant patrons' coffee cups, it is not always known whether the patron is drinking regular or decaf. The server has to carry a pot of each in order to make sure the customer is properly served. This limits the server's ability to carry out any other tasks while topping off customer's coffee because both hands are being utilized. The two pot coffee distribution method also makes it difficult to open doors and maneuver around crowded or cramped restaurants.

Additionally, many coffee pots do not close completely. A coffee pot that remains open while in transit not only allows the hot coffee to cool, but poses a spilling hazard, which could lead to spills and injuries through slipping or burning.

### SUMMARY OF THE INVENTION

It is an object of the present invention to provide a beverage container that allows for more efficient, versatile, and safe beverage distribution. This invention provides a beverage container that has multiple compartments and a lid that may open to any of them at one time or remain in a position in which the container is fully closed.

### BRIEF DESCRIPTION OF THE DRAWINGS

FIG. 1 is a perspective view of an embodiment according to the present invention.

FIG. 2 is an exploded view of the embodiment shown in FIG. 1.

FIG. 3 is a side elevation cross-sectional view of an embodiment along Line 3-3 of FIG. 1.

FIG. 4 is a side elevation cross-sectional view of the embodiment of FIG. 1 along Line 4-4.

FIGS. 5A-5C are top elevation views of the embodiment of the invention shown in FIG. 1.

FIG. 6 is a top elevation view of another embodiment of the present invention.

FIG. 7 is a side elevation cross-sectional view along line 7-7 of the embodiment of FIG. 6.

FIG. 8 is a perspective view of an alternate embodiment of a coffee pot according to the present invention.

FIG. 9 is an exploded view of the coffee pot of FIG. 8.

FIG. 10 is a cross-sectional view of the coffee pot of FIG. 8.

FIG. 11 is a partial cross-sectional view of the coffee pot of FIG. 8, depicting the top portion of the coffee pot.

FIG. 12A is an exploded perspective view of the top portion of the coffee pot of FIG. 8.

FIG. 12B demonstrates the lid in FIG. 12A being secured to the coffee pot.

FIGS. 13A-13C show overhead views of the coffee pot of FIG. 8, demonstrating the pouring spout being moved from one chamber within the coffee pot to another.

FIG. 14 depicts a coffee pot of the present invention being filled simultaneously with two separate liquids, e.g. regular coffee and decaffeinated coffee.

FIG. 15 demonstrates a person pouring one of the liquids contained in the coffee pot.

FIG. 16 demonstrates a person switching from one liquid container to the second liquid container.

FIG. 17 demonstrates a person pouring the second liquid contained in the coffee pot.

### DESCRIPTION OF THE PREFERRED EMBODIMENT

Although the disclosure hereof is detailed and exact to enable those skilled in the art to practice the invention, the physical embodiments herein disclosed merely exemplify the invention which may be embodied in other specific structures. While the preferred embodiment has been described, the details may be changed without departing from the invention.

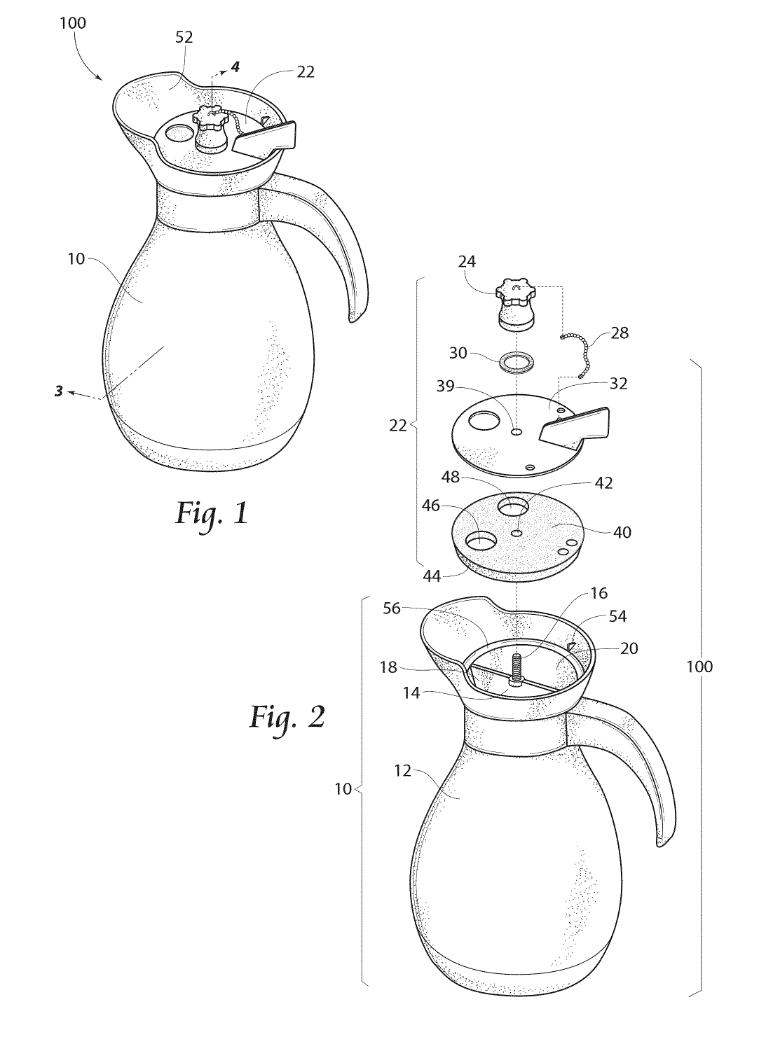

Referring now to FIG. 1, a general arrangement of one representative embodiment of a coffee pot 100 exemplifying the invention is shown. The coffee pot 100 comprises a vessel assembly 10, a lid assembly 22, and a collar 52. The various parts of the coffee pot 100 may be metal, plastic, or any other material or combination of materials suitable for the intended use of the invention.

Looking now to FIG. 2, an exploded view of the coffee pot 100 is depicted. The lid assembly 22 is comprised of a securing knob 24, a tether 28, roller bearings 30, a pivoting plate 32, and a stationary plate 40. Furthermore, the vessel assembly 10 is comprised of a vessel body 12, a partition 14, a threaded securing stud 16, and in this embodiment, a first compartment 18 and a second compartment 20.

Still referring to FIG. 2, the partition 14 and the stationary plate 40 prohibit liquid (not shown) from leaking out of the first compartment 18 and into the second compartment 20, or vice versa, or into any other neighboring compartments (not shown). The stationary plate 40 sits atop the partition 14 with the stationary plate's peripheral surface 44 abutting the vessel body's opening lip 56. The stationary plate 40 also has a hole 42 through which the securing stud 16 is placed. The stationary plate 40 may be comprised of a type of rubber, foam, or other material capable of preventing liquid leakage.

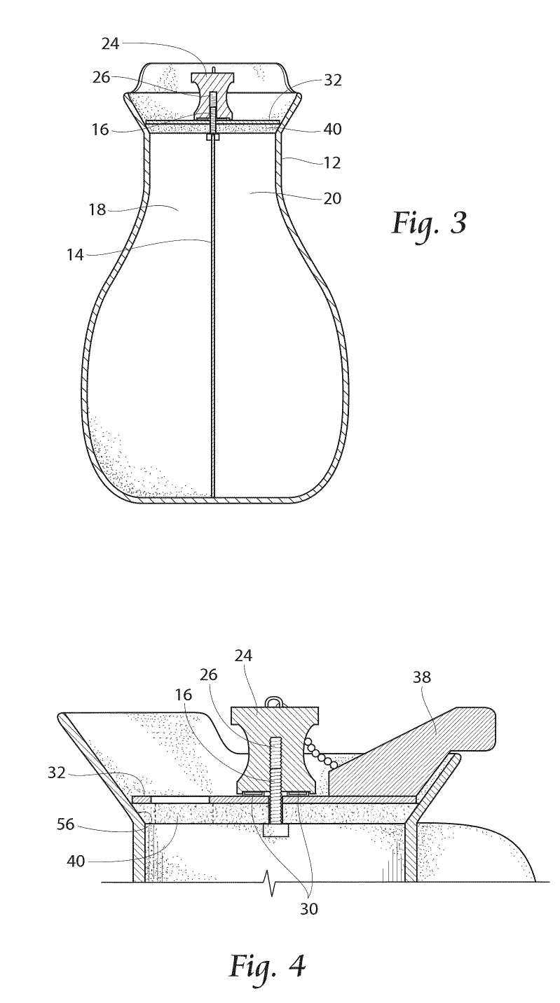

Furthermore, as seen in FIGS. 3 and 4, the pivoting plate 32 sits atop the stationary plate 40 and the securing knob 24 secures both of the plates 32, 40 to the vessel body 12 and to the partition 14. The pivoting plate 32 also has a hole 39 (see FIG. 2) through which the securing stud 16 is placed. As shown in the figures, the securing knob 24 has a threaded internal cavity 26 that interfaces with the threaded securing stud 16. A roller bearing 30, e.g. a needle bearing, is positioned between the securing knob 24 and the pivoting plate 32 which allows the securing knob 24 to fully seal the stationary plate 40 to the vessel body 12 and the partition 14 while still allowing the pivoting plate 32 to rotate. In addition, when the securing knob 24 is removed when filling the compartments 18, 20, the securing knob 24 may be attached to the pivoting plate 32 via a tether 28 (see FIG. 2).

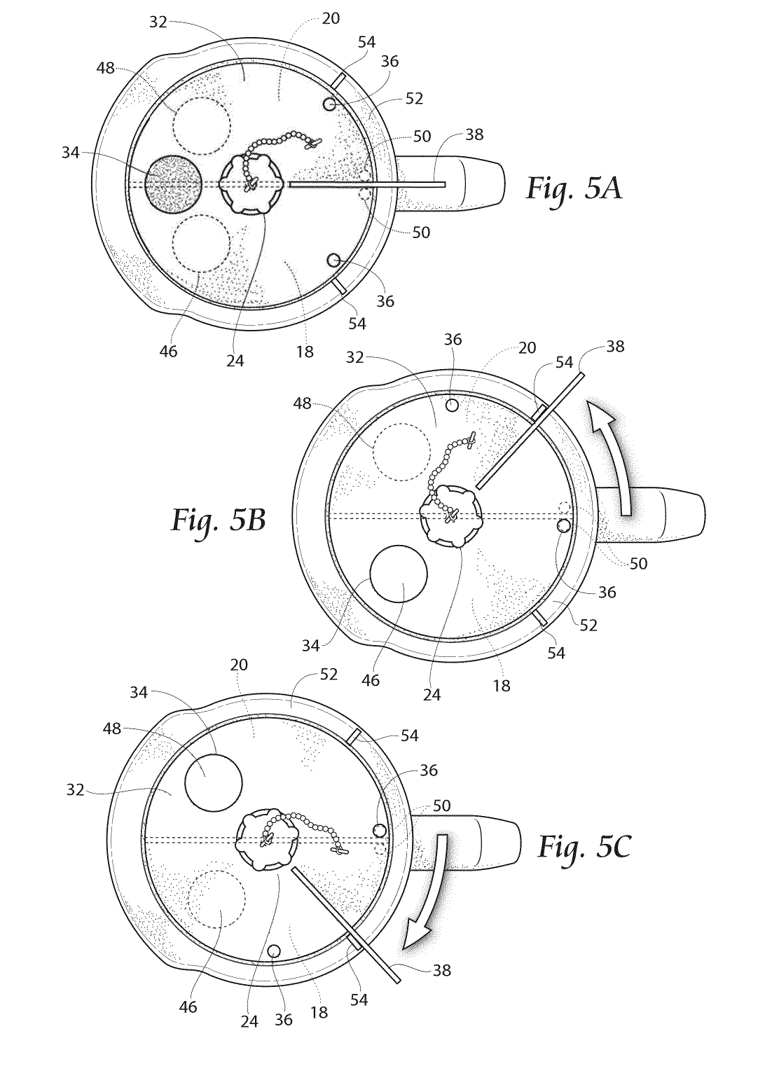

Moving on to FIGS. 5A-5C, the pivoting plate 32 is shown in various positions. In FIG. 5A the pivoting plate 32 is in a closed position as its aperture 34 is not located over the stationary plate's first compartment aperture 46 nor the stationary plate's second compartment aperture 48.

Also shown in FIGS. 5A-5C are vents 50 located on the stationary plate 40 and vents 36 located on the pivoting plate 32. When the pivoting plate 32 is rotated to an open position (FIGS. 5B and 5C), a stationary plate vent 50 will align with a pivoting plate vent 36 to allow air into the corresponding compartment to prevent a vacuum from occurring inside the compartment while pouring.

In the two-compartment embodiment presented in FIGS. 5B and 5C, the pivoting plate is shown in the two open positions. In FIG. 5B, the pivoting plate's aperture 34 is located over the first compartment aperture 46 and in FIG. 5C the pivoting plate's aperture 34 is located over the second compartment aperture 48. The pivoting plate 32 has a fin 38 (also shown in FIG. 3) that allows a user to switch between the two compartments 18, 20. Applying a force to the fin 38 in either a clockwise or a counterclockwise radial direction causes the pivoting plate 32 to rotate. Stops 54 located on the collar 52 limit the travel of the pivoting plate 32 by abutting the fin 38 and also ensure proper alignment of the pivoting plate aperture 34 over one of the stationary plate apertures 46, 48.

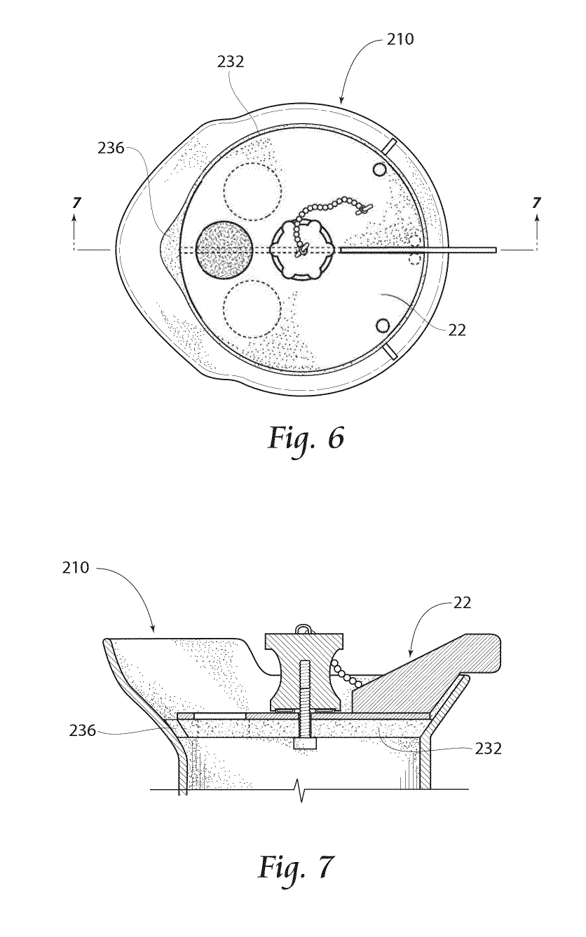

Certain vessels may require alternatively shaped stationary plates to prevent leakage. In FIGS. 6 and 7 an alternative stationary plate 232 with a lobe 236 is shown to fit the contour of the alternative vessel 210. Therefore, it should be known that the lid assembly 22 may be configured to fit this and other vessel shapes to ensure a proper seal.

Moreover, it should be known that the present invention may embody other shapes and therefore should not be perceived as being limited to only a bifurcated coffee pot. The scope of the invention also includes multi-compartment containers for carrying and distributing various types of liquids. That being said, provided that a container has at least two compartments and is capable of moving between the different compartments in a liquid tight manner as shown, such a design would fall within the scope of the present invention.

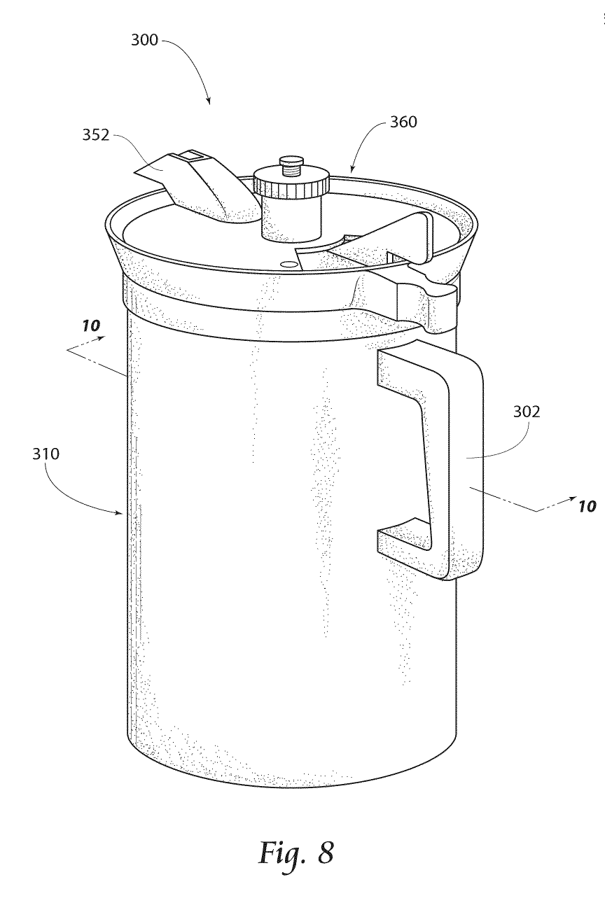

FIG. 8 provides a second embodiment 300 of the coffee pot of the present invention. The coffee pot 300 is configured similarly to the coffee pot 100, wherein the coffee pot 300 provides two separate components for carrying and distributing various types of liquids. The coffee pot 300 provides an alternate arrangement of a lid assembly 360 for sealing the coffee pot 300. The coffee pot 300 generally comprises a vessel assembly 310, a pouring spout 352, and the lid assembly 360. The vessel assembly 310 further includes a handle 302 that allows the coffee pot 300 to pour coffee or other liquids from the coffee pot 300.

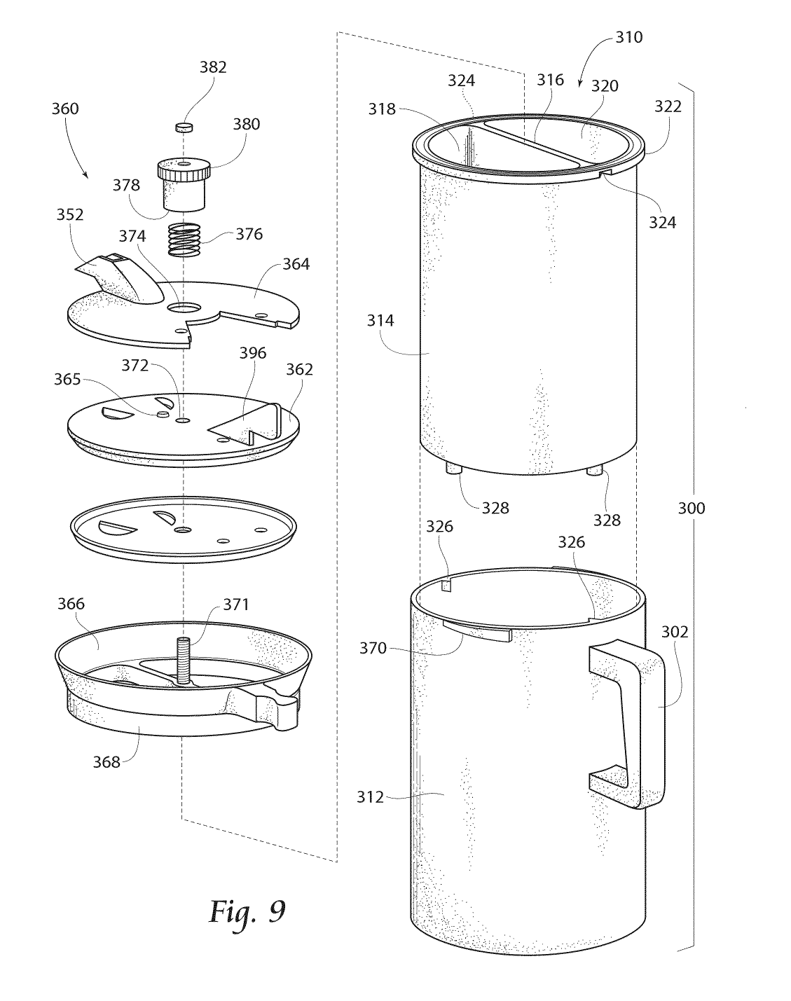

Referring now to FIG. 9, an exploded view of the coffee pot 300 is shown. The vessel assembly 310 generally comprises a vessel body 312 that receives a removable liquid holding reservoir 314. The liquid holding reservoir 314 has a partition 316, which provides for a first liquid compartment 318 and a second liquid compartment 320. The holding reservoir has a rim 322 that includes a pair of notches 324. The notches 324 correspond to indents 326 located on the vessel body 312, which allows the holding reservoir 314 to be held securely in place within the vessel body 312. The reservoir 314 also has a plurality of feet 328 are designed to rest on the bottom of the vessel body 312 without the entire reservoir needing to rest on the vessel body 312. When situated within the vessel body 312, there will be a space between the reservoir 314 and the vessel body 312, thereby providing a barrier between the reservoir 314 and the vessel body 312 to minimize the transfer of heat from the liquid within the reservoir 314 to the exterior of the vessel body and to any person using the coffee pot 300.

Still referring to FIG. 9, the lid assembly 360 generally comprises a pivot plate 362, a stationary plate 364, a seal 367, and a securing collar 366. The seal 367 is designed with openings to align with apertures in the stationary plate 364. The securing collar 366 includes a pair of securing slots 368 that will interact with a pair of opposing ramps 370 located on the vessel body 312, thereby securing the lid assembly 260 the body assembly 310. The securing collar 366 includes a threaded securing stud 371, which intersects the pivot plate 362 and the stationary collar 366 through a pair of respective holes 372, 374. The threaded securing stud 370 will then pass through a spring 376 and threaded within a channel 378 of a securing knob 380. A cap 382 may be placed upon the securing knob 380 to cover the channel 378. When the securing knob 380 is tightened downwardly onto the threaded securing stud 370, the resultant arrangement provides a fluid tight arrangement for the lid assembly 360 which, as will be discussed further below, allows for the pivot plate 362 to pivot between the first and second liquid compartments 318 and 320.

Referring further to FIG. 9, the vessel body 312 has a pair of oppositely disposed ramps 330, which will interact with a pair of oppositely disposed slots 368 located on the securing collar 366. The arrangement provides a quick connect and removal of the lid assembly 360 from the vessel body 312, while able to provide a fluid tight arrangement when in a locked position.

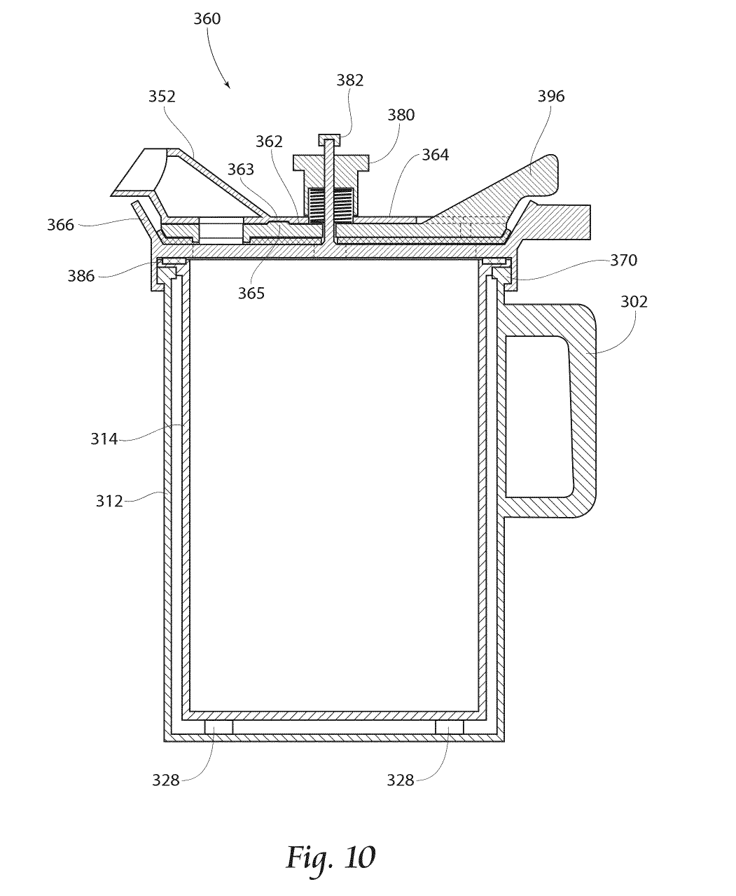

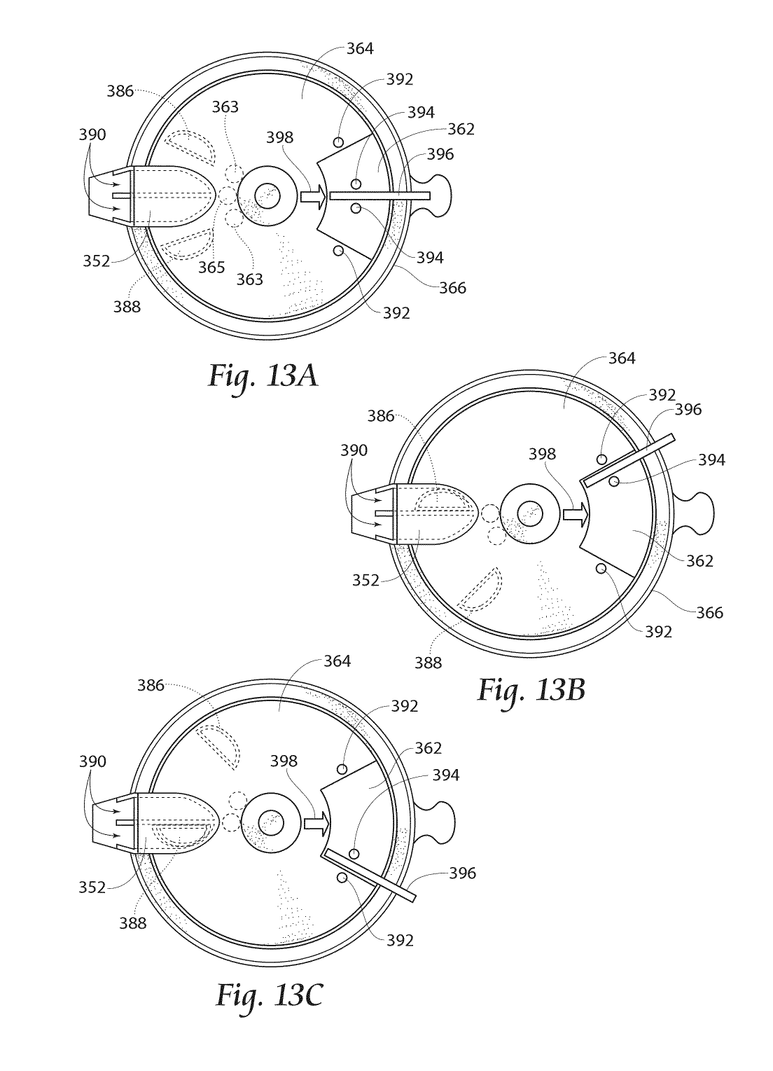

FIG. 10 provides a cross-sectional view of the coffee pot 300. As previously noted, the fluid reservoir 314 is spaced apart from the vessel body 312. The lid assembly 360 securely sits upon the vessel body 312, with a seal 386 located between the lid assembly 360 and the vessel body to prevent leakage. The threading of the stud 370 with securing knob 380 secured the lid assembly 360 together in a fashion that will not prohibit pivoting of the pivot plate 362. Also shown is a securing ball 363, which will be used to hold the pivot plate 362 in place when pouring beverage, as demonstrated below in FIGS. 13A-13C.

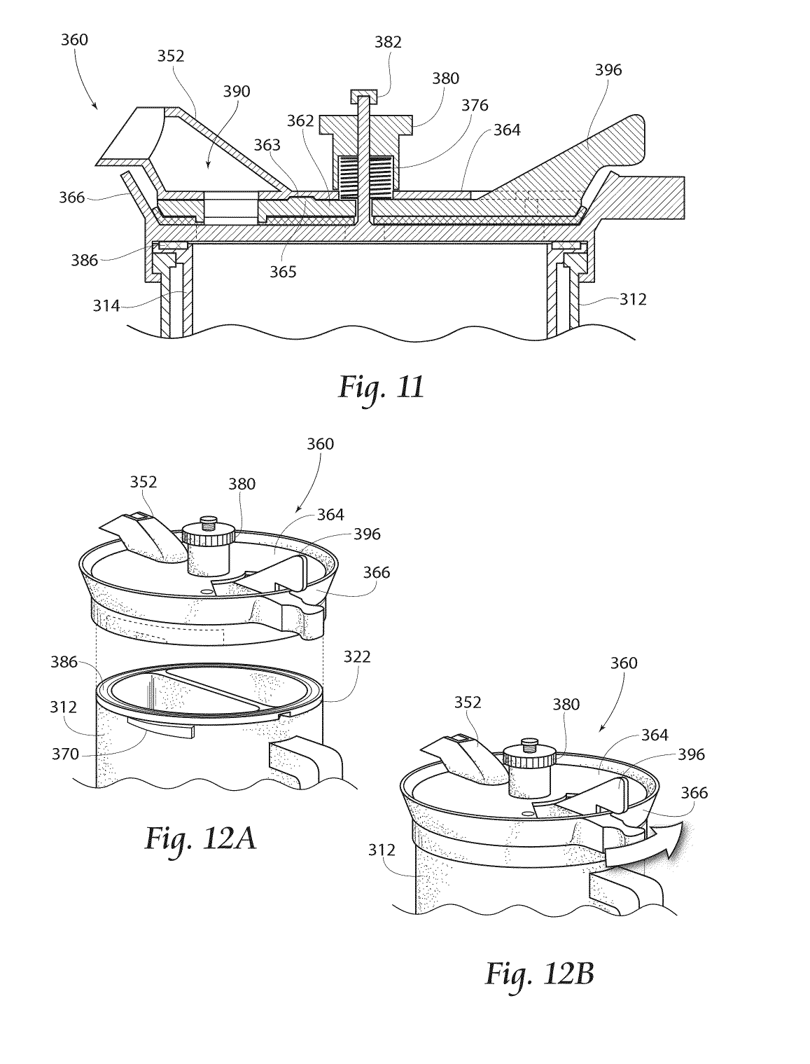

FIG. 11 is a partial cross-sectional view of the coffee pot 300, focusing on the lid assembly 360 and highlighting the ability for the lid assembly 360 to provide a fluid tight arrangement with the vessel assembly 310, while allowing for the pivot plate 362 to pivot between the two fluid chambers 318, 320. The lid assembly is secured together with the stud 370 and the securing knob 380, as shown, with the stud intersecting the three working sections of the lid assembly, the securing collar 366, the stationary plate 364, and the pivot plate 362, as well as the seal 367.

Referring further to FIG. 11, the fluid tight arrangement between the lid assembly 360 and the vessel assembly 310 is also depicted. The slots 368 of the lid assembly 360 are shown fitted together with the ramps 330 of the vessel assembly, in a manner that will allow the lid assembly 360 and the vessel assembly 310 to be easily and quickly attached and separated from one another, as demonstrated in FIGS. 12A and 12B.

FIG. 12A depicts the lid assembly 360 separated from the vessel assembly 310 and positioned directly above the vessel assembly 310. The slots 284 are lined up with the ramps 330. Once properly aligned, the lid assembly 360 will be placed upon the vessel assembly 310. The lid assembly 360 will then be rotated, as shown in FIG. 12B, which will lock the lid assembly 360 securely on the vessel assembly 310 in a liquid tight fashion. To remove the lid assembly 360 from the vessel assembly 310, the lid assembly will be rotated in the opposite direction.

FIGS. 13A-13C demonstrate the movement of the lid assembly 360 to pivot between one of the two liquid compartments 318 and 320. The pivot plate has a pair of apertures 386 and 388 positioned to correspond with one of the liquid compartments 318, 320. The stationary plate 364 has a bifurcated opening 390. Located over the spout 352. As shown in FIG. 13A, the pivoting plate 362 is in a closed position as neither aperture 386, 388 is positioned over the opening 390.

Also shown in FIGS. 13A-13C are vents 392 located on the stationary plate 364 and vents 394 located on the pivoting plate 362. When the pivoting plate 262 is rotated to an open position (FIGS. 5B and 5C), a stationary plate vent 392 will align with a pivoting plate vent 394 to allow air into the corresponding compartment to prevent a vacuum from occurring inside the compartment while pouring. The pivoting plate has a fin 396 which, when applied with pressure, will rotate in either a first or second direction, as shown in FIGS. 13B and 13C. An alignment marker 298 is provided on the pivoting plate 362 and centrally aligned with the fin 396 to indicate a closed position.

FIGS. 13B and 13C, the pivoting plate is shown in the two open positions. In FIG. 13B, the pivoting plate's aperture 286 is located over the opening 390 and in FIG. 13C the pivoting plate's aperture 388 is located over the opening 390. The fin 396 of pivoting plate 362 allows a user to switch between the two compartments 318, 320. The pivot plate has a detent 365 that will nestle over the securing ball 363 when the pivot plate 362 is in the proper position. Applying a force to the fin 396 in either a clockwise or a counterclockwise radial direction causes the pivoting plate 362 to rotate. The pivoting plate 362 also has stops 398 to limit the travel of the pivoting plate 362 by abutting the fin 396 and also ensure proper alignment of the pivoting plate aperture 386 or 388 over the opening 390. The arrangement allows for easy selection between one of the fluid compartments 318, 320, without loosening of the lid assembly 360 with respect to the vessel assembly 310.

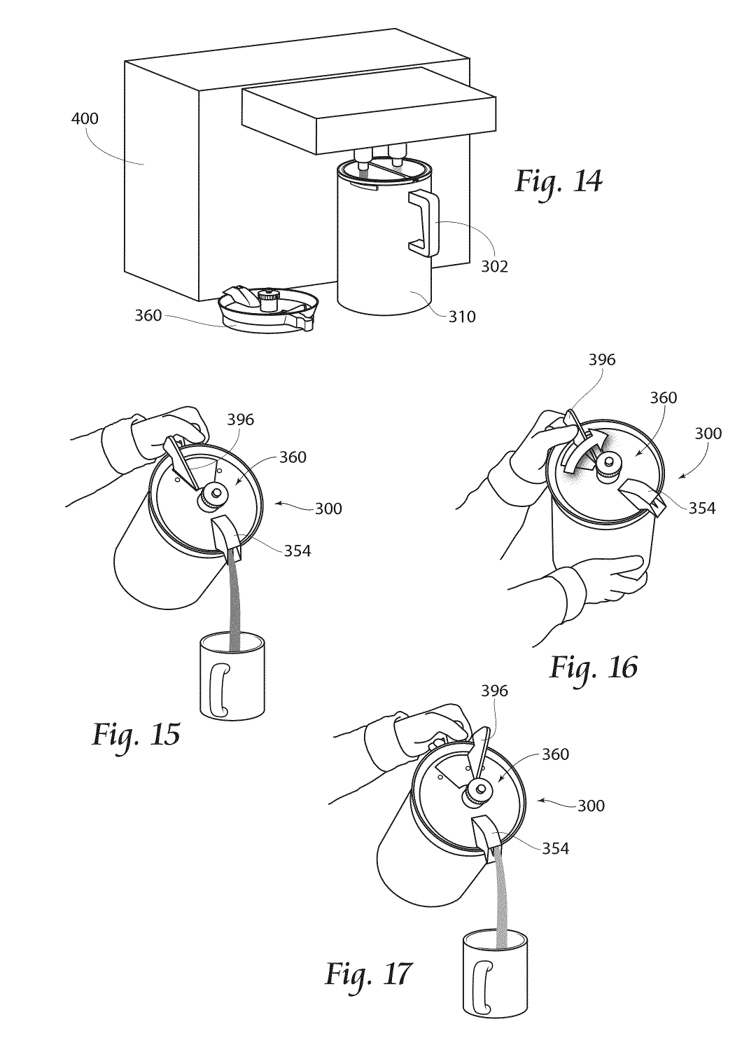

The coffee pots according to the present invention provide for an efficient method for serving more than one beverage from the same container. Together with the coffee pots of the present invention, a beverage dispensing system 400, such as shown in FIG. 14, may assist in providing multiple beverages efficiently. For example, the beverage dispensing system 400 may be able to discharge two different beverages, e.g. regular coffee and decaffeinated coffee. The lid assembly 360 will be removed from the vessel assembly 310, thereby allowing the two compartments 318 and 320 to be filled with a respective beverage. Once filled, the lid assembly 360 will be reconnected to the vessel assembly 310, and coffee be dispensed as shown in FIGS. 15-17.

FIG. 15 shows the pivot plate 362 with the fin 396 rotated clockwise, thereby allowing the first fluid compartment 318 to be accessed and allowing the user to pour a first beverage, e.g. regular coffee. When the second beverage is requested, e.g. decaffeinated coffee, the user will grab the coffee pot 300, as shown in FIG. 16, and rotate the fin 396 counterclockwise, thereby allowing the second fluid compartment 320 to be accessed. The user can then pour the second beverage, e.g. decaffeinated coffee, as shown in FIG. 17. As necessary, the pivot plate 362 can be moved between the position in FIGS. 15 and 17 as necessary. The result is a more efficient process for delivering more than one distinct beverage from a beverage container.

The foregoing is considered as illustrative only of the principles of the invention. Furthermore, since numerous modifications and changes will readily occur to those skilled in the art, it is not desired to limit the invention to the exact construction and operation shown and described. While the preferred embodiment has been described, the details may be changed without departing from the invention.

We claim:

1. A beverage dispensing container comprising:
a vessel body;
a liquid reservoir located in the vessel body, the liquid reservoir having at least two separate liquid compartments; and
means for selectively accessing one of the liquid compartments, whereby liquid is only dispensed from the accessed compartment.

2. The beverage dispensing container according to claim 1 wherein the means for selectively accessing one of the liquid compartments comprises a lid assembly secured to said vessel body and said liquid reservoir.

3. The beverage dispensing container according to claim 2 where the lid assembly comprises
a stationary plate; and
a pivoting plate comprising at least two apertures, wherein each of said apertures corresponds to one of said liquid compartments.

4. The beverage dispensing container according to claim 3 wherein the lid assembly further comprises a collar for securing the lid assembly to the vessel body.

5. The beverage dispensing container according to claim 1 wherein the liquid reservoir is removable from the vessel body.

6. A beverage dispensing container comprising:
a vessel body;
a spout located on said vessel body;
a liquid reservoir located in the vessel body, the liquid reservoir having at least two separate liquid compartments; and
a lid assembly removably secured to the liquid reservoir and the vessel body, said lid assembly allowing for selective dispensing of liquid from one of said liquid compartments.

7. The beverage dispensing container according to claim 6, wherein said lid assembly further comprises:
a stationary plate;
a pivoting plate comprising at least two apertures, wherein each of said apertures corresponds to one of said liquid compartments;
a collar for securing the lid assembly to the vessel body; and
a stud for securing the lid assembly and providing fluid tight arrangement with the liquid reservoir.

8. The beverage dispensing container according to claim 7 wherein the stationary plate has a bifurcated opening, wherein each branch of said bifurcated opening corresponds to one of said liquid compartments.

9. The beverage dispensing container according to claim 7 wherein the collar further comprises a pair of oppositely disposed slots arranged to interact with a pair of oppositely disposed ramps located on said vessel body for releasably locking the lid assembly to the vessel body.

10. The beverage dispensing container according to claim 6 further comprising a handle.

11. The beverage dispensing container according to claim 6 wherein the liquid reservoir is removable.
